(19) United States
(12) Patent Application Publication
(10) Pub. No.: US 2026/0243058 A1
(43) Pub. Date: Aug. 20, 2026

(54) Recovery Of Electric Work Vehicles

(71) Applicant: Caterpillar Inc., Peoria, IL (US)

(72) Inventor: Thomas Twigger, Spalding, Lincolnshire (GB)

(21) Appl. No.: 19/469,817

(22) PCT Filed: Mar. 8, 2024
(86) PCT No.: PCT/US2024/019078

§ 371 Date: Sep. 26, 2025

(30) Foreign Application Priority Data
Apr. 21, 2023 (GB) 2305901.7

(51) Int. Cl. E02F 9/20; B60L 1/00; B60L 1/02; B60L 1/14; B60L 15/20; B60L 15/32; B60L 50/53; B60L 53/53; B60L 53/57; E02F 9/22

(52) U.S. Cl. CPC E02F 9/207; B60L 1/003; B60L 15/2045; B60L 15/32; B60L 50/53; B60L 53/53; B60L 53/57; E02F 9/2203; B60L 1/02; B60L 1/14; B60L 2200/40; B60L 2240/421; B60L 2250/16

(57) ABSTRACT

A method is provided of operating an electric work vehicle in a recovery mode, the electric work vehicle comprising a traction motor and a battery. The recovery mode is initiated via a user interface. A charging interlock is disabled, wherein when enabled the charging interlock is configured to prevent use of the traction motor of the electric work vehicle during charging. The electric work vehicle is set to a low power consumption mode, wherein the traction motor of the electric work vehicle is operable in the low power consumption mode. The battery of the electric work vehicle is connected to a mobile power supply such that the mobile power supply provides power to the electric work vehicle. While the electric work vehicle is connected to the mobile power supply, the method comprises (a) moving the electric work vehicle using the traction motor; and (b) moving the mobile power supply.

### FIELD OF THE DISCLOSURE

The disclosure relates to the field of electric work vehicles.

### BACKGROUND

Electric work vehicles are known to be used in remote or inaccessible locations. In an event that an electric work vehicle runs out of charge away from a charging module, providing power to the stranded vehicle may be difficult. For example, the stranded vehicle may be in an inconvenient or dangerous location, to which it would be impractical to transport a charging module with sufficient power to charge the electric vehicle. Furthermore, it may be impractical or dangerous to charge the electric vehicle at that location. It may be beneficial to relocate the stranded vehicle to a safer location as soon as possible.

### SUMMARY OF THE DISCLOSURE

Against this background, there is provided a method of operating an electric work vehicle in a recovery mode, the electric work vehicle comprising a traction motor and a battery. The method comprises initiating the recovery mode via a user interface. The method further comprises disabling a charging interlock, wherein when enabled the charging interlock is configured to prevent use of the traction motor of the electric work vehicle during charging. The method further comprises setting the electric work vehicle to a low power consumption mode, wherein the traction motor of the electric work vehicle is operable in the low power consumption mode. The method further comprises connecting the battery of the electric work vehicle to a mobile power supply such that the mobile power supply provides power to the electric work vehicle. While the electric work vehicle is connected to the mobile power supply, the method further comprises (a) moving the electric work vehicle using the traction motor; and (b) moving the mobile power supply.

In this way, the electric work vehicle may be slowly driven while tethered to an alternative power source, to allow the electric work vehicle to be moved when at low or zero charge. Advantageously, the electric work vehicle may be moved closer to a charging module, charger or other power supply configured to charge the electric work vehicle. the electric work vehicle may be moved away from dangerous or inconvenient locations to a safer or more convenient location.

There is also provided a device configured to operate an electric work vehicle in a recovery mode, the electric work vehicle comprising a traction motor and a battery. The device is configured to receive instructions from a user interface to initiate the recovery mode. The device is further configured to disable a charging interlock, wherein when enabled the charging interlock is configured to prevent use of the traction motor of the electric work vehicle during charging. The device is further configured to set the electric work vehicle to a low power consumption mode, wherein the traction motor of the electric work vehicle is operable in the low power consumption mode. The device is further configured to connect the battery of the electric work vehicle to a mobile power supply. While the electric work vehicle is connected to the mobile power supply, the device is further configured to move the electric work vehicle using the traction motor.

### BRIEF DESCRIPTION OF THE DRAWINGS

A specific embodiment of the disclosure will now be described, by way of example only, with reference to the accompanying drawings in which:

FIG. 1 shows a flowchart illustrating a method of operating an electric work vehicle in a recovery mode according to an embodiment of the present disclosure.

FIG. 2 shows a schematic diagram illustrating an electric work vehicle in a recovery mode carrying a mobile power supply.

FIG. 3 shows a schematic diagram illustrating an electric work vehicle in a recovery mode connected to a mobile power supply carried by a support electric work vehicle.

FIG. 4 shows a schematic diagram illustrating an electric work vehicle in a recovery mode connected to a recovery electric work vehicle.

### DETAILED DESCRIPTION

A method of operating an electric work vehicle in a recovery mode is provided. The electric work vehicle comprises a traction motor and a battery. The traction motor comprises an electric motor and is configured to provide propulsion for the electric work vehicle. The electric work vehicle may comprise any electric work vehicle configured to operate on a work site. For example, the electric work vehicle may comprise a work vehicle comprising a work tool. The electric work tool may comprise a wheeled vehicle or a tracked vehicle.

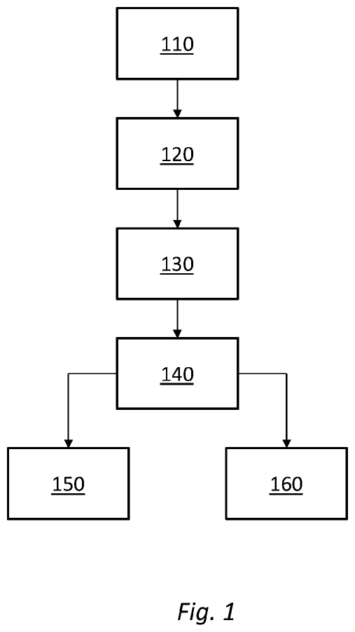

With reference to FIG. 1, a method is illustrated of operating an electric work vehicle in a recovery mode. The recovery mode may, for example, be used in an event that the electric work vehicle is at a low or zero state of charge and is located such that the electric work vehicle has insufficient charge to reach a charging module. The recovery mode may be used to allow the electric work vehicle to reach a charging module or other power supply. The method comprises initiating the recovery mode via a user interface at step 110. At step 120, a charging interlock is disabled. When enabled, the charging interlock is configured to prevent use of the traction motor of the electric work vehicle during charging. During normal charging, the recovery mode is not initiated and the charging interlock is enabled such that use of the traction motor is enabled during charging. Enabling the charging interlock may occur automatically when the electric work vehicle is connected to a charger or when charging begins, or the charging interlock may be enabled by a user. Step 120 of disabling the charging interlock means that in an event that the electric work vehicle is connected to a power supply or is charged, the traction motor can still be used. At step 130, the method comprises setting the electric work vehicle to a low power consumption mode. In the low power consumption mode, the traction motor of the electric work vehicle is operable. At step 140, the battery of the electric work vehicle is connected to a mobile power supply such that the mobile power supply provides power to the electric work vehicle. While the electric work vehicle is connected to the mobile power supply, the method comprises moving the electric work vehicle using the traction motor at step 150, and moving the mobile power supply at step 160. Steps 150 and 160 may occur simultaneously or sequentially. In an event that steps 150 and 160 occur sequentially, steps 150 and 160 may be repeated.

The electric work vehicle may further comprise a work tool motor configured to actuate a work tool. When enabled, the charging interlock may be configured to prevent use of the work tool motor of the electric work vehicle during charging. The work tool motor may be configured to raise and lower a work tool. The work tool motor may be configured to power an actuator. For example, the work tool motor may be configured to control a boom, wherein a distal end of the boom is configured to be attached to a work tool. The work tool motor may be configured to control a boom and stick, wherein a distal end of the stick is configured to be attached to a work tool. In the low power consumption mode, the work tool motor may be operable. For example, it may be beneficial to be able to raise a work tool using the work tool motor before moving the electric work vehicle at step 150. In an event that the electric work vehicle is configured to carry the mobile power supply, the work tool motor may allow the mobile power supply to be lifted. In certain embodiments, the work tool motor may comprise a hydraulic motor.

The low power consumption mode may comprise a low speed mode of the traction motor. The low speed mode of the traction motor may set an upper limit on the speed of the traction motor, such that the electric work vehicle is prevented from moving above a certain propulsion speed. In other words, the torque of the traction motor may be kept below a certain threshold. In certain embodiments, the low speed mode of the traction motor may be pre-set. In certain embodiments, the low speed mode of the traction motor may be configurable by an operator. The operator may configure the low speed mode to have a lower upper limit on the speed of the traction motor in an event that terrain is more difficult or there are more obstacles in the vicinity of the electric work vehicle, or a higher upper limit on the speed of the traction motor in an event that terrain is more gentle or there are fewer obstacles in the vicinity of the electric work vehicle. For example, the operator may choose from more than one low speed mode, wherein each low speed mode has a different upper limit on the speed of the traction motor. In another example, the operator may choose an upper limit of a propulsion speed for the electric work vehicle, such as from a pre-set range of propulsion speeds.

In certain embodiments, the low power consumption mode may comprise an idle mode of one or more work tools of the electric work vehicle. The idle mode of the one or more work tools may prevent the one or more work tools from being used. The idle mode of the one or more work tools may allow for steering and basic implement operation. The work tool motor may be operable in the low power consumption mode, for example to allow a work tool to be raised before the electric work vehicle is moved. In an event that the electric work vehicle is configured to carry the mobile power supply, the work tool motor may be operable in the low power consumption mode to allow the mobile power supply to be lifted. The low power consumption mode may limit the operation of the work tool motor, for example to limit the speed of the work tool motor or to only allow the work tool to be raised.

In certain embodiments, the low power consumption mode may comprise a low power mode of an ancillary electrical load or a standby mode of an ancillary electrical load. The ancillary electrical load may comprise any load configured to draw power from the battery of the electric work vehicle. The ancillary electrical load may comprise one or more of lights; a cab heater; a cab heating, ventilation and air conditioning (HVAC) system; a cooling fan; and a cooling pump.

The step 110 of initiating the recovery mode via a user interface may comprise initiating the recovery mode at the electric work vehicle or remotely. A user may initiate the recovery mode via a user interface of the electric work vehicle. A user may initiate the recovery mode wirelessly. In certain embodiments, the user interface may comprise a display in a cab of the electric vehicle or a display outside of the cab of the electric vehicle. In certain embodiments, the user interface may comprise a mobile device configured to wirelessly communicate with the electric vehicle.

The mobile power supply may comprise any power source configured to charge a battery. The mobile power supply may be configured to connect to the charge port of the electric work vehicle. The mobile power supply may be configured to connect to the charge port of the electric work vehicle via an AC cable or via a DC cable. The mobile power supply is movable. In certain embodiments, the mobile power supply may be configured to be carried or towed. In other embodiments, the mobile power supply may be configured to travel to the electric work vehicle without being carried or towed. For example, the mobile power supply may comprise a traction motor or may comprise a vehicle.

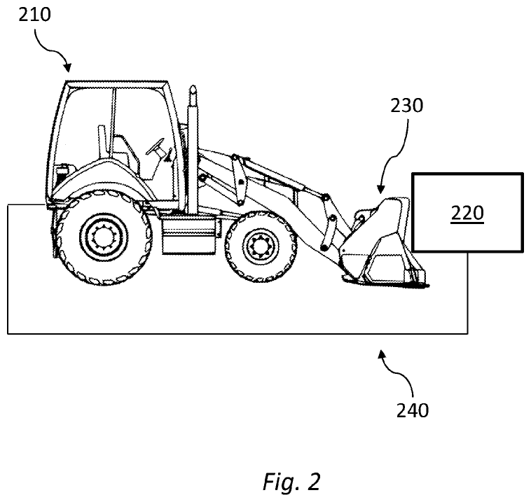

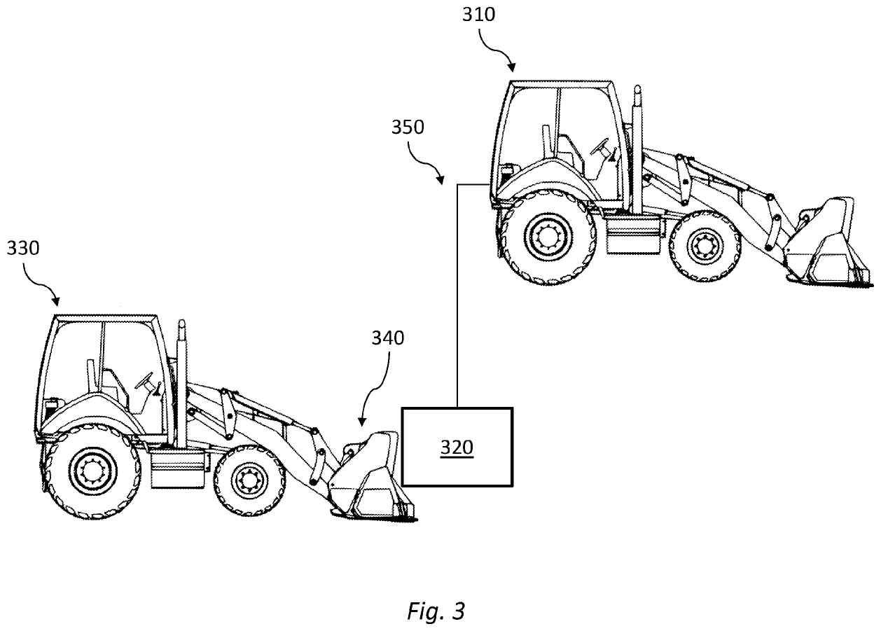

In certain embodiments, the mobile power supply may comprise a generator or genset. In certain embodiments, the mobile power supply may comprise one or more batteries. The electric work vehicle in the recovery mode may be configured to carry or tow the mobile power supply. For example, with reference to FIG. 2, the electric work vehicle 210 in the recovery mode may carry the mobile power supply 220 using a work tool 230 of the electric work vehicle such as a bucket or fork. The mobile power supply 220 may be connected to the electric work vehicle 210 via a cable 240 connected to the charge port of the electric work vehicle 210. In an event that the electric work vehicle in the recovery mode carries the mobile power supply, step 150 of moving the electric work vehicle using the traction motor and step 160 of moving the mobile power supply occur simultaneously. The electric work vehicle in the recovery mode may otherwise tow the mobile power supply, or carry the mobile power supply via a coupler, or transport the mobile power supply in some other way. In another example, with reference to FIG. 3, a support electric work vehicle 330 may be configured to carry the mobile power supply 320, wherein the support electric work vehicle 330 is not in the recovery mode. The support electric work vehicle may be configured to carry or tow the mobile power supply. The support electric work vehicle may, for example, be configured to carry the mobile power supply using a work tool of the support electric work vehicle such as a bucket or fork or via a coupler. The mobile power supply 320 may be connected to the electric work vehicle 310 in the recovery mode via a cable 350 connected to the charge port of the electric work vehicle 310 in the recovery mode. In an event that the support electric work vehicle not in the recovery mode carries the mobile power supply, step 150 of moving the electric work vehicle using the traction motor and step 160 of moving the mobile power supply may occur simultaneously or sequentially. The power provided by the mobile power supply to the electric work vehicle may be AC power. The power provided by the mobile power supply to the electric work vehicle may be DC power.

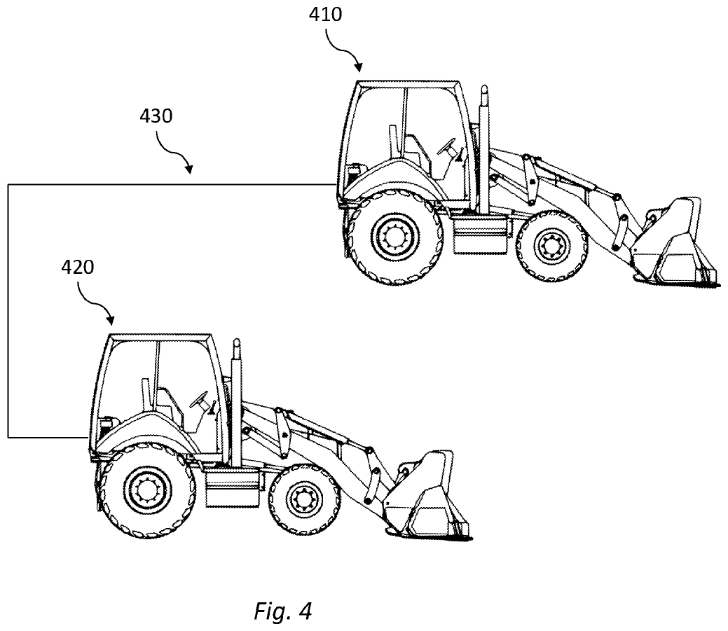

With reference to FIG. 4, in certain embodiments the mobile power supply may comprise a recovery electric work vehicle 420. The battery of the recovery electric work vehicle 420 may be connected via a cable 430 to the charging port of the electric work vehicle 410 in the recovery mode. At step 140 of connecting the battery of the electric work vehicle to the mobile power supply, the battery of the electric work vehicle may be connected to a battery of the recovery electric work vehicle, wherein the battery of the recovery electric work vehicle is configured to power the recovery electric work vehicle. Step 150 of moving the electric work vehicle using the traction motor and step 160 of moving the mobile power supply may occur simultaneously, such that the electric work vehicle in recovery mode and the recovery electric work vehicle move at the same time and while the battery of the electric work vehicle is connected to the battery of the recovery electric work vehicle. Step 150 of moving the electric work vehicle using the traction motor and step 160 of moving the mobile power supply may occur sequentially, such that the electric work vehicle in recovery mode and the recovery electric work vehicle do not move at the same time while the battery of the electric work vehicle is connected to a battery of the recovery electric work vehicle. The power provided by the recovery electric work vehicle to the electric work vehicle may be DC power. The recovery electric work vehicle 420 may be operable while providing power to the electric work vehicle 410 in the recovery mode. The recovery electric work vehicle 420 may be put into a recover mode while providing power to the electric work vehicle 410 in the recovery mode. The recovery electric work vehicle 420 may be put into a low power consumption mode while providing power to the electric work vehicle 410 in the recovery mode. The charging interlock of the recovery electric work vehicle 420 may be disabled while the recovery electric work vehicle 420 is providing power to the electric work vehicle 410 in the recovery mode.

In certain embodiments, the power provided by the mobile power supply to the electric work vehicle may be kept at or below a power limit.

The method may further comprise enabling the charging interlock once the electric work vehicle is no longer in the recovery mode. The recovery mode may be ended by a user, via the user interface. The recovery mode may be ended when the electric work vehicle is turned off.

In certain embodiments, initiating the recovery mode may comprise selecting or confirming one or more parameters of the mobile power supply via the user interface. The one or more parameters may be used to set properties of the recovery mode. For example, the one or more parameters may be used to determine the power limit of the power provided by the mobile power supply. The one or more parameters may comprise one or more of a size, capacity, type and connection type of the mobile power supply. For example, selecting or confirming the one or more parameters may comprise selecting whether the mobile power supply has a 1-phase connection or a 3-phase connection.

Step 150 of moving the electric work vehicle may comprise a driver moving the electric work vehicle. In other embodiments, the electric work vehicle may be moved without a driver, either by remote control or autonomously. In an event that the mobile power supply is carried by a support electric vehicle or the mobile power supply comprises a recovery electric vehicle, the support electric vehicle or the recovery electric vehicle may be moved by a driver, by remote control, autonomously, or by communication with the electric work vehicle in recovery mode.

There is further provided a device configured to operate an electric work vehicle in a recovery mode, the electric work vehicle comprising a traction motor and a battery. The device may be configured to carry out any of the methods described herein.

The device is configured to receive instructions from a user interface to initiate the recovery mode. The device is further configured to disable a charging interlock, wherein when enabled the charging interlock is configured to prevent use of the traction motor of the electric work vehicle during charging. The device is further configured to set the electric work vehicle to a low power consumption mode, wherein the traction motor of the electric work vehicle is operable in the low power consumption mode. The device is further configured to connect the electric work vehicle to a mobile power supply. While the electric work vehicle is connected to the mobile power supply, the device is further configured to move the electric work vehicle using the traction motor.

1. A method of operating an electric work vehicle in a recovery mode, the electric work vehicle comprising a traction motor and a battery, the method comprising:
initiating the recovery mode via a user interface;
disabling a charging interlock, wherein when enabled the charging interlock is configured to prevent use of the traction motor of the electric work vehicle during charging;
setting the electric work vehicle to a low power consumption mode, wherein the traction motor of the electric work vehicle is operable in the low power consumption mode;
connecting the battery of the electric work vehicle to a mobile power supply such that the mobile power supply provides power to the electric work vehicle; and
while the electric work vehicle is connected to the mobile power supply:
(a) moving the electric work vehicle using the traction motor; and
(b) moving the mobile power supply.

2. The method of claim 1 wherein the electric work vehicle further comprises a work tool motor configured to actuate a work tool, wherein the work tool motor is operable in the low power consumption mode.

3. The method of claim 2 wherein the work tool motor comprises a hydraulic motor.

4. The method of claim 1 wherein the low power consumption mode comprises a low speed mode of the traction motor.

5. The method of claim 1 wherein the low power consumption mode comprises an idle mode of one or more work tools of the electric work vehicle.

6. The method of claim 1 wherein the low power consumption mode comprises a low power mode of an ancillary electrical load or a standby mode of an ancillary electrical load.

7. The method of claim 6 wherein the ancillary electrical load comprises one or more of:
lights;
a cab heater;
a cab HVAC system;
a cooling fan; and
a cooling pump.

8. The method of claim 1 wherein the user interface comprises one of:
a display in a cab of the electric work vehicle;
a display outside of the cab of the electric work vehicle; and
a mobile device configured to wirelessly communicate with the electric work vehicle.

9. The method of claim 1 wherein the mobile power supply comprises one or more of:
a generator; and
one or more batteries.

10. The method of claim 1 wherein the electric work vehicle in the recovery mode is configured to carry or tow the mobile power supply.

11. The method of claim 1 wherein a support electric work vehicle is configured to carry the mobile power supply, wherein the support electric work vehicle is not in the recovery mode.

12. The method of claim 1 wherein the mobile power supply comprises a recovery electric work vehicle.

13. The method of claim 12 wherein the power provided by the mobile power supply to the electric work vehicle is DC power.

14. The method of claim 1 wherein the power provided by the mobile power supply to the electric work vehicle is at or below a power limit.

15. A device configured to operate an electric work vehicle in a recovery mode, the electric work vehicle comprising a traction motor and a battery, the device configured to:
receive instructions from a user interface to initiate the recovery mode;
disable a charging interlock, wherein when enabled the charging interlock is configured to prevent use of the traction motor of the electric work vehicle during charging;
set the electric work vehicle to a low power consumption mode, wherein the traction motor of the electric work vehicle is operable in the low power consumption mode;
connect the battery of the electric work vehicle to a mobile power supply; and
while the electric work vehicle is connected to the mobile power supply, move the electric work vehicle using the traction motor.
